(19) United States
(12) Patent Application Publication
(10) Pub. No.: US 2017/0186440 A1
(43) Pub. Date: Jun. 29, 2017

(54) METHOD, DEVICE AND STORAGE MEDIUM FOR PLAYING AUDIO

(71) Applicant: Xiaomi Inc., Beijing (CN)

(72) Inventors: Quanming Long, Beijing (CN); Guiming Long, Beijing (CN); Taozheng Sun, Beijing (CN)

(73) Assignee: Xiaomi Inc., Beijing (CN)

(21) Appl. No.: 15/363,175

(22) Filed: Nov. 29, 2016

(30) Foreign Application Priority Data
Dec. 23, 2015 (CN) 201510980320.2

(51) Int. Cl. G10L 19/22; G10L 19/008

(52) U.S. Cl. CPC G10L 19/22; G10L 19/008

(57) ABSTRACT

The present disclosure relates to a method, a device and storage medium for selecting a media device to play an audio file based on determined attributes of media devices. The selection process includes acquiring a first audio decoding parameter of a third party terminal externally connected to a split-type host, and a second audio decoding parameter of the split-type host. The selection process further includes selecting a device with a greater converting capability from the third party terminal and the split-type host according to the first audio decoding parameter and a second audio decoding parameter. The selected device then plays the audio by the selected device, wherein both the first and second audio decoding parameters include at least a scheme for audio decoding.

### CROSS REFERENCE TO RELATED APPLICATION

This application claims priority to Chinese Patent Application No. 201510980320.2, filed on Dec. 23, 2015, the entirety of which is hereby incorporated by reference herein.

### TECHNICAL FIELD

The present disclosure relates to the field of video and audio playback technology, and more particular, to a method, a device and storage medium for playing audio based on detected audio playback capabilities of a device.

### BACKGROUND

A split-type television (TV) refers to a TV set of which some combination of an image displaying part, a signal processing part, and an audio system are separated. For example, a split-type TV may include a standalone screen and a split-type host. The standalone screen may be configured to display images, and the split-type host may include a built-in audio system to process audio signals and output sound. While updating hardware configuration of the split-type TV, it is possible to directly replace the split-type host while reserving the standalone screen, thereby reducing the cost for hardware configuration upgrade. Accordingly, the split-type TV has become more and more popular.

Currently, further to be used in conjunction with the standalone screen, the split-type host can be externally connected to a third party media device and be used in conjunction with the third party media device. The third party media device may, for example, include a third party TV, a disk player, a general player, and the like. Due to the fact that audio may be played either by the built-in audio system of the split-type host, or by the externally connected third party media device, while the audio is generally required to be played by one device, it is necessary to provide a method for playing audio when the split-type host is externally connected to the third party media device.

### SUMMARY

The present disclosure provides a method, a device and storage medium for playing audio.

According to a first embodiment of the present disclosure, there is provided a method for playing audio, the method including: acquiring a first audio decoding parameter, the first audio decoding parameter being an audio decoding parameter of a third party media device externally connected to a split-type host, the first audio decoding parameter being used for describing a converting capability for converting a digital audio signal into an analog audio signal; selecting a device with a greater converting capability from the third party media device and the split-type host according to the first audio decoding parameter and a second audio decoding parameter, the second decoding parameter being an audio decoding parameter of the split-type host; and playing the audio using the selected device, wherein both the first and second audio decoding parameters include at least a scheme for audio decoding.

According a second embodiment of the present disclosure, there is provided a device for playing audio, the device including: a processor; and a memory for storing instructions executable by the processor, wherein the processor is configured to perform: acquiring a first audio decoding parameter, the first audio decoding parameter being an audio decoding parameter of a third party media device externally connected to a split-type host, the first audio decoding parameter being used for describing a converting capability for converting a digital audio signal into an analog audio signal; selecting a device with a greater converting capability from the third party media device and the split-type host according to the first audio decoding parameter and a second audio decoding parameter, the second decoding parameter being an audio decoding parameter of the split-type host; and playing the audio using the selected device, wherein both the first and second audio decoding parameters include at least a scheme for audio decoding.

According to a third embodiment of the present disclosure, there is provided a non-transitory computer-readable storage medium storing instructions, executable by a processor in a terminal, for performing a method for playing audio, the method including: acquiring a first audio decoding parameter, the first audio decoding parameter being an audio decoding parameter of a third party media device externally connected to a split-type host, the first audio decoding parameter being used for describing a converting capability for converting a digital audio signal into an analog audio signal; selecting a device with a greater converting capability from the third party media device and the split-type host according to the first audio decoding parameter and a second audio decoding parameter, the second decoding parameter being an audio decoding parameter of the split-type host; and playing the audio using the selected device, wherein both the first and second audio decoding parameters include at least a scheme for audio decoding.

It is to be understood that both the foregoing general description and the following detailed description are exemplary and explanatory only and are not restrictive of the present disclosure.

### BRIEF DESCRIPTION OF THE DRAWINGS

The accompanying drawings, which are incorporated in and constitute a part of this specification, illustrate embodiments consistent with the present disclosure and, together with the description, serve to explain the principles of the present disclosure.

FIG. 1 is a schematic diagram illustrating a configuration of the system for playing audio according to an exemplary embodiment.

FIG. 2 is a schematic diagram illustrating another configuration of the system for playing audio according to an exemplary embodiment.

FIG. 3 is a flow chart illustrating a method for playing audio according to an exemplary embodiment.

FIG. 4 is a flow chart illustrating another method for playing audio according to an exemplary embodiment.

FIG. 5 is a block diagram illustrating a device for playing audio according to an exemplary embodiment.

FIG. 6 is a block diagram illustrating a selection module according to an exemplary embodiment.

FIG. 7 is a block diagram illustrating another selection module according to an exemplary embodiment.

FIG. 8 is a block diagram illustrating another selection module according to an exemplary embodiment.

FIG. 9 is a block diagram illustrating a first acquiring module according to an exemplary embodiment.

FIG. 10 is a block diagram illustrating a third acquiring unit according to an exemplary embodiment.

FIG. 11 is a block diagram illustrating another device for playing audio according to an exemplary embodiment.

FIG. 12 is a block diagram illustrating another selection module according to an exemplary embodiment.

FIG. 13 is a block diagram illustrating another device for playing audio according to an exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the present disclosure. Instead, they are merely examples of devices and methods consistent with aspects related to the present disclosure as recited in the appended claims.

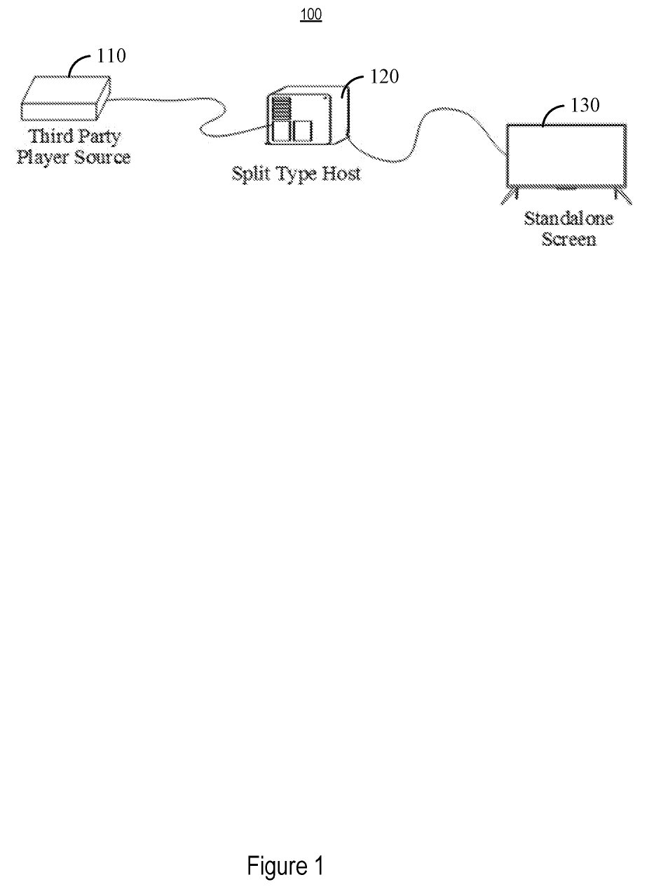

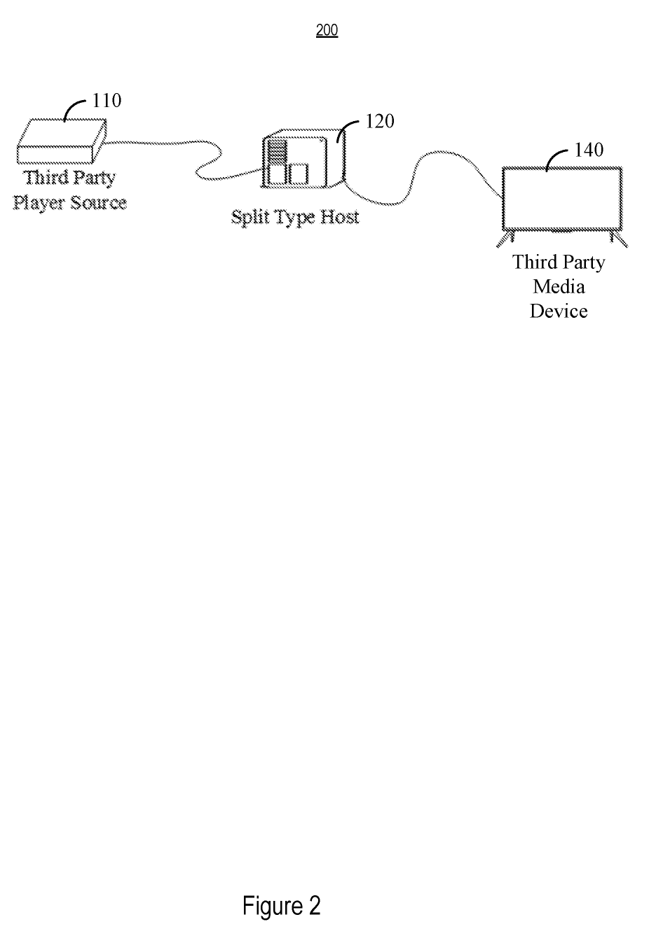

Before describing the embodiments of the present disclosure in detail, a system architecture according to embodiments of the present disclosure will be introduced firstly. As illustrated in FIG. 1, the system 100 includes a third party player source 110, a split-type host 120, and a standalone screen 130. The split-type host 120 may be a media player such as, for example, a mobile phone, a computer, a digital broadcast terminal, a messaging device, a gaming console, a tablet, a medical device, exercise equipment, a personal digital assistant, or the like, that may be connected to other media devices such as the third party player source 110 and the standalone screen 130, where the split-type host 120 may be configured to output audio corresponding to an image or video display being displayed on the third party player source 110 or standalone screen 130. The split-type host 120 may further be configured to be responsible for processing signals (e.g., control signals, audio signals, video signals) for control and/or routing media (e.g., audio signals and/or video signals) to connected media devices. The split-type host 120 may be connected to the standalone screen 130 through a designated interface such as, for example, a high definition multimedia interface (HDMI). The split-type host 120 may be configured to process signals and play audio information, and the standalone screen 130 is configured to display an image. In addition to being connected to the standalone screen 130, the split-type host 120 may be further externally connected to a third party player source 110, which is a device for providing a video source or an audio source. The third party player source 110 may be a player source with or without an audio playing function. Further, in addition to being connected to the standalone screen 130 through the HDMI, the split-type host 120 may be further externally connected to a third party media device 140 through the HDMI, as shown in FIG. 2.

When the split-type host 120 is connected to one or more other media devices that are capable of outputting audio, the split-type host 120 may compare certain attributes of the connected media devices to determine which media device may output a superior quality audio. The media device that is determined to output superior quality audio may then be selected by the split-type host 120 to output the audio information. The attributes considered by the split-type host 120 may include an audio signal conversion capability of the media device for converting a digital audio signal into an analog audio signal, a number of audio channels available on the media device, and an audio signal sampling frequency of the media device.

Referring to FIG. 2, the third party media device 140 may perform both image displaying and audio playing, and the split-type host 120 may be further externally connected to a third party player source 110 in addition to being externally connected to the third party media device 140.

Based on the above FIG. 1, when the split-type host 120 is connected to the standalone screen 130 and the third party player source 110, the standalone screen 130 is used to display images, and the split-type host 120 may be used to play audio. In the case where the third party player source 110 has a function for playing audio, the third party player source 110 may also be used to play audio. Accordingly, the system 100 may include two devices having audio playing function. Based on the above FIG. 2, when the split-type host 120 is connected to the third party media device 140 and the third party player source 110, both the split-type host 120 and third party media device 140 may be used to play audio. In the case where the third party player source 110 has a function for playing audio, the third party player source 110 may also be used to play audio. Accordingly, the system 200 may include three devices capable of playing audio. Generally, audio information may be played by only one device, and thus embodiments of the present disclosure provide a method for playing audio information such that one device may be selected from a plurality of devices having audio playing functionality to play certain audio information.

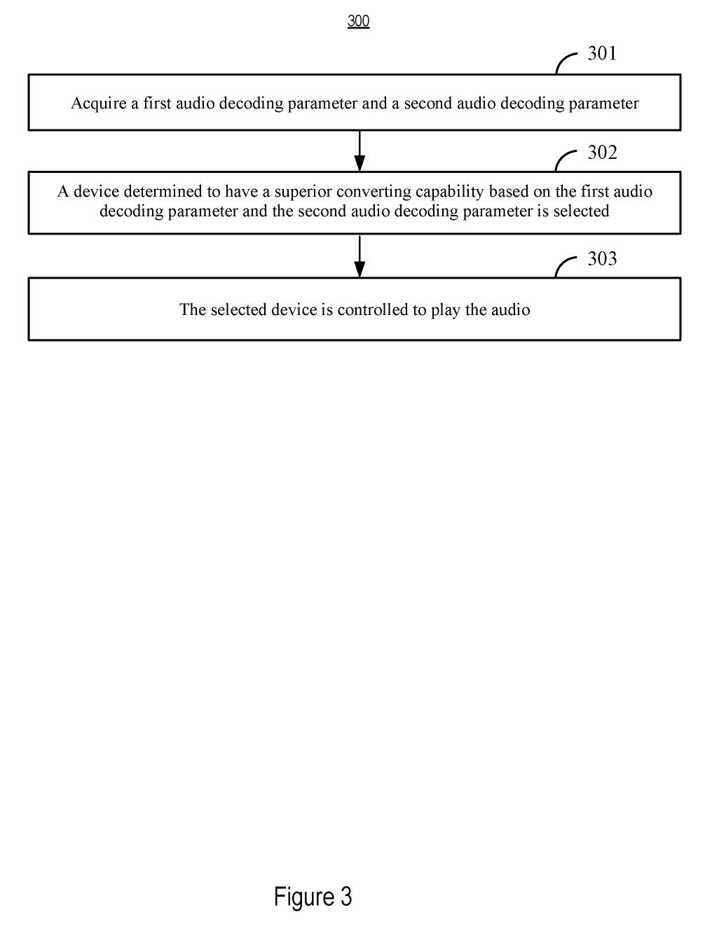

FIG. 3 shows a flowchart 300 of logic illustrating a method for playing audio according to an exemplary embodiment of the present disclosure. As illustrated in FIG. 3, the method for playing audio is applicable in a split-type host such as the split-type 120 in system 200. The method may include the following processes.

In step S301, a first audio decoding parameter and a second audio decoding parameter is acquired. The first audio decoding parameter is an audio decoding parameter of the third party media device 140 externally connected to the split-type host 120, and the first audio decoding parameter is used for describing a converting capability for converting a digital audio signal into an analog audio signal by the third party media device 140. The second decoding parameter is an audio decoding parameter of the split-type host 120, and the second audio decoding parameter is used for describing a converting capability for converting a digital audio signal into an analog audio signal by the split-type host 120.

In step 302, a device determined to have a superior converting capability is selected from between the third party media device 140 and the split-type host 120 according to the first audio decoding parameter and a second audio decoding parameter.

In step 303, the audio is played on the selected device.

In the present embodiment, both the first and second audio decoding parameters include at least a scheme for audio decoding. The scheme for audio decoding refers to a process for decoding audio information in the third party media device 140. The scheme for audio decoding may include a pulse code modulation (PCM), an audio coding 3(AC3), a digital theater system (DTS), a linear predictive coding (LPC) or the like. However, embodiments of the present disclosure are not limited thereto.

In the embodiments of the present disclosure, as both the split-type host 120 and the third party media device 140 may play audio and may have different playing effects, it is possible to compare the first audio decoding parameter with the second audio decoding parameter, so as to select a device with a superior converting capability as the device for playing audio, thereby improving an audio playing effect and an accuracy of device selection.

In another embodiment of the present disclosure, the first and second audio decoding parameters may further include at least one of a sampling frequency and a number of audio channel.

In another embodiment of the present disclosure, the step of selecting a device with a superior converting capability from the third party media device 140 and the split-type host 120 according to the first audio decoding parameter and a second audio decoding parameter includes the steps as follows.

A first number and a second number are determined that correspond to the third party media device 140 and the split-type host 120, respectively. The first number is a number corresponding to the scheme for audio decoding included in the first audio decoding parameter, and the second number is a number corresponding to the scheme for audio decoding included in the second audio decoding parameter. For example, when the scheme for audio decoding included in the first audio decoding parameter is a PCL, an AC3 and a DTS, the first number is three (3); and when the scheme for audio decoding included in the second audio decoding parameter is a PCL and a DTS, the second number is two (2). In this case, the first number (three) is greater than the second number (two), and thus the third party media device 140 is determined as the device with a greater converting capability.

When the first number is greater than the second number, it is determined that the third party media device 140 is the device with a superior converting capability.

When the first number is smaller than the second number, it is determined that the split-type host 120 is the device with a superior converting capability.

In another embodiment of the present disclosure, after the step of determining the first number and the second number, the method may further include the steps as follows.

When the first number equals to the second number and when the first and second audio decoding parameters further include a sampling frequency, a first sampling frequency and a second sampling frequency may be acquired. The first sampling frequency is a sampling frequency included in the first audio decoding parameter, and the second sampling frequency is a sampling frequency included in the second audio decoding parameter. The sampling frequency refers to a number of audio samples per second the respective device is able to process.

When the first sampling frequency is greater than the second sampling frequency, it is determined that the third party media device 140 is the device with a superior converting capability.

When the first sampling frequency is smaller than the second sampling frequency, it is determined that the split-type host 120 is the device with a superior converting capability.

In another embodiment of the present disclosure, after the step of determining the first number and the second number, the method may further include the steps as follows.

When the first number equals to the second number and when the first and second audio decoding parameters further include a number of audio channels, a first number of audio channels and a second number of audio channels corresponding to the third party media device 140 and the split-type host 120, respectively, are acquired. The first number of audio channels is a number of audio channels included in the first audio decoding parameter, and the second number of audio channels is a number of audio channels included in the second audio decoding parameter.

When the first number of audio channels is greater than the second number of audio channels, it is determined that the third party third party media device 140 is the device with a superior converting capability.

When the first number of audio channels is smaller than the second number of audio channels, it is determined that the split-type host 120 is the device with a superior converting capability.

According to another embodiment of the present disclosure, the step of acquiring a first audio decoding parameter includes the following.

An extended display identification data (EDID) included in the third party media device 140 is read through a designated interface. The first audio decoding parameter may be acquired from the EDID of the third party third party media device 140.

According to another embodiment of the present disclosure, the step of acquiring the first audio decoding parameter from the EDID of the third party media device 140 includes the steps as follows.

A data document is acquired from the EDID of the third party third party media device 140 according to a designated path. The designated path may describe a file path leading to a location of the data document stored within the EDID.

The first audio decoding parameter is acquired from the data document.

According to another embodiment of the present disclosure, before the step of selecting a device with a superior converting capability from the third party media device 140 and the split-type host 120 according to the first audio decoding parameter and a second audio decoding parameter, the method includes the step as follows.

An EDID of the split-type host 120 is accessed and read. The second audio decoding parameter may be acquired from the EDID of the split-type host 120.

According to another embodiment of the present disclosure, the step of selecting a device with a superior converting capability from between the third party media device 140 and the split-type host 120 according to the first audio decoding parameter and a second audio decoding parameter includes the steps as follows.

When the split-type host 120 is further externally connected to the third party player source 110 having an audio playing function, a third audio decoding parameter may be acquired. The third audio decoding parameter is an audio decoding parameter of the third party player source 110.

A device with a superior converting capability is selected from between the third party media device 140, the split-type host 120, and the third party player source 110, according to the first audio decoding parameter, the second audio decoding parameter and the third audio decoding parameter.

Further alternative embodiments of the present disclosure may be obtained by combining any of the above alternative technical solutions, which will not be described in detail herein.

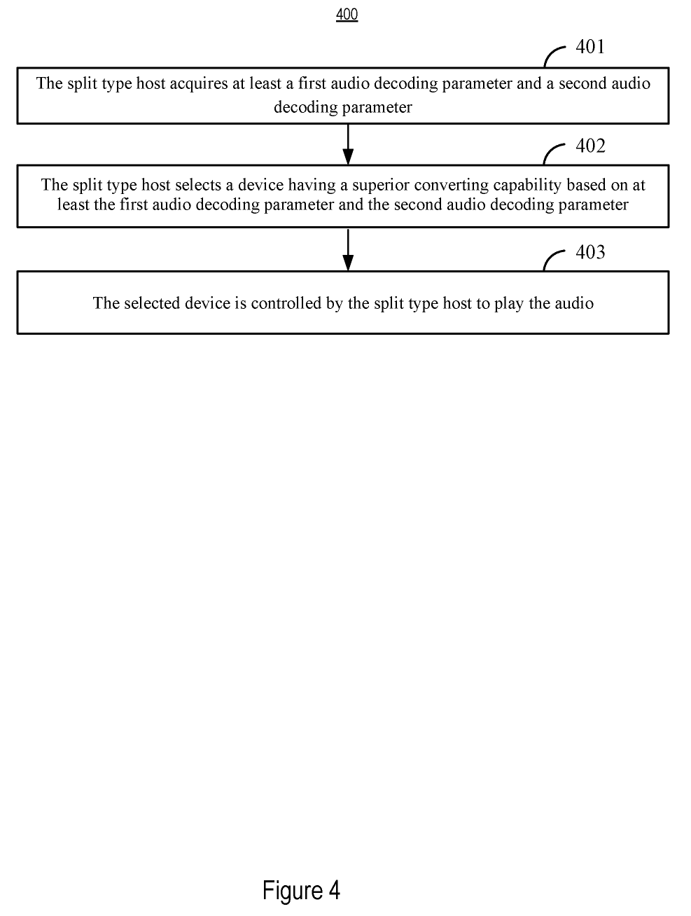

FIG. 4 shows a flow chart 400 of logic illustrating another method for playing audio according to an exemplary embodiment. Referring to FIG. 4, the method includes the steps as follows.

In step 401, the split-type host 120 acquires a first audio decoding parameter and a second audio decoding parameter. The first audio decoding parameter is an audio decoding parameter of a third party media device 140 externally connected to the split-type host 120, and the first audio decoding parameter is used for describing a converting capability for converting a digital audio signal into an analog audio signal by the third party media device 140. The second decoding parameter is an audio decoding parameter of the split-type host 120, and the second audio decoding parameter is used for describing a converting capability for converting a digital audio signal into an analog audio signal by the split-type host 120.

Both the third party media device 140 and the split-type host 120 may be capable of playing audio. Thus, in order to compare the audio playing capabilities of the third party media device 140 with that of the split-type host 120 and select a device with better audio playing capabilities, the split-type host 120 may acquire the first audio decoding parameter. The operation of the split-type host 120 to acquire the first audio decoding parameter may include: reading an EDID of the third party media device 140 through a designated interface; and acquiring the first audio decoding parameter from the EDID of the third party media device 140.

In one embodiment, an operation for the split-type host 120 to acquire the first audio decoding parameter from the EDID of the third party media device 140may include: acquiring a data document from the EDID of the third party media device 140 according to a data file location designated path; and acquiring the first audio decoding parameter from the data document.

It should be noted that the designated path is a path for acquiring the data document from the EDID, and the designated path may be configured in advance since the data document is generally positioned in a fixed position in the EDID. However, the present disclosure is not limited thereto.

In addition, the data document may refer to a document including information regarding the audio configuration in the EDID. For example, the data document may be a Consumer Electronics Association-861 (CEA-861) document, that is, an uncompressed digital video standard developed by the CEA. However, the present disclosure is not limited thereto.

Further, when the split-type host 120 acquires the data document of the third party media device 140, the split-type host 120 may acquire the corresponding audio decoding parameter from the data document based on an audio decoding parameter identifier, and determines the acquired audio decoding parameter as the first audio decoding parameter.

It should be noted that the audio decoding parameter identifier is used to identify the audio decoding parameter uniquely. The audio decoding parameter identifier may be, for example, a name of the audio decoding parameter. Optionally, the audio decoding parameter identifier may be a constant number of the audio decoding parameter, or other identifiers, which is not limited in the embodiments of the present disclosure.

For example, when the designated path is EDID->CEA BLOCK->DATA BLOCK, the split-type host may acquire the data document of “DATA BLOCK” according to the designated path leading to the “DATA BLOCK” data document. In the case where the audio decoding parameter identifier is “Audio”, the split-type host may acquire the audio decoding parameter corresponding to the “Audio” from the “DATA BLOCK” according to the audio decoding parameter identifier “Audio”, and determine the acquired audio decoding parameter as the first audio decoding parameter.

Further, the designated interface may be configured to acquire the EDID of the third party media device 140. The designated interface may be an HDMI or other interfaces, which is not limited in the embodiments of the present disclosure.

It should be noted that the first audio decoding parameter includes at least a scheme for audio decoding. The scheme for audio decoding refers to the scheme for decoding audio information in the third party media device 140. The scheme for audio decoding may include a pulse code modulation (PCM), an audio coding 3 (AC3), a digital theater system (DTS), a linear predictive coding (LPC) or the like. However, embodiments of the present disclosure are not limited thereto.

It should be noted that when the split-type host 120 is externally connected to the standalone screen 130, the split-type host 120 will not require the designated interface to obtain the first audio decoding parameter as the standalone screen 130 does not include an audio playing function. However, when the split-type host 120 is externally connected to the third party media device 140, the split-type host 120 may acquire the first audio decoding parameter through the designated interface as the third party media device 140 includes an audio playing function.

Further, in addition to the scheme for audio decoding, the first audio decoding parameter may further include at least one of a sampling frequency and a number of audio channels. The first audio decoding parameter may also include other parameters such as a number of bits of the audio, which is not limited in the embodiments of the present disclosure.

In step 402, the split-type host 120 selects a device with a superior converting capability from between the third party media device 140 and the split-type host 120 according to the first audio decoding parameter and a second audio decoding parameter. The second decoding parameter is an audio decoding parameter of the split-type host 120.

The converting capability may indicate the capability for converting a digital audio signal into an analog audio signal, and thus when the device has a greater converting capability, the device may have a better audio playing quality when playing audio. Accordingly, in order to achieve a better audio playing quality, the split-type host 120 may select a device with a superior converting capability from the third party media device 140 and the split-type host 120 according to the first audio decoding parameter and a second audio decoding parameter. The first audio coding parameter and the second audio coding parameter include at least a scheme for audio decoding, and thus the operation of the split-type host 120 to select a device with a superior converting capability from the third party media device 140 and the split-type host 120 according to the first audio decoding parameter and a second audio decoding parameter may include: determining a first number and a second number corresponding to the third party media device 140 and the split-type host 120, respectively, the first number being a number of the scheme for audio decoding included in the first audio decoding parameter, and the second number being a number of the scheme for audio decoding included in the second audio decoding parameter; determining that the third party media device 140 is the device with a superior converting capability when the first number is greater than the second number; and determining that the split-type host 120 is the device with a superior converting capability when the first number is smaller than the second number.

For example, when the scheme for audio decoding included in the first audio decoding parameter is a PCL, an AC3 and a DTS, the first number is three (3); and when the scheme for audio decoding included in the second audio decoding parameter is a PCL and a DTS, the second number is two (2). In this case, the first number (three) is greater than the second number (two), and thus the third party media device 140 is determined as the device with a superior converting capability.

For another example, when the scheme for audio decoding included in the first audio decoding parameter is a PCL, and an AC3, the first number may be assigned as two (2); and when the scheme for audio decoding included in the second audio decoding parameter is a PCL, an AC3, and a DTS, the second number may be assigned as three (3). In this case, the first number (two) is less than the second number (three), and thus the split-type host 120 is determined as the device with a superior converting capability.

For yet another example, when the scheme for audio decoding included in the first audio decoding parameter is a PCL, and an AC3, the first number may be assigned as two (2); and when the scheme for audio decoding included in the second audio decoding parameter is a PCL, and a DTS, the second number may also be assigned as two (2). In this case, the first number (two) equals to the second number (two), and thus one of the split-type host 120 and the third party media device 140 may be randomly determined as the device with a superior converting capability.

It should be noted that, in addition to the scheme for audio decoding, the second audio decoding parameter may further include at least one of a sampling frequency and a number of audio channels. The second audio decoding parameter may also include other parameters such as a number of bits of the audio, which is not limited in the embodiments of the present disclosure.

In addition, when the first number equals to the second number, and when the first and second audio decoding parameters further include a sampling frequency, a first sampling frequency and a second sampling frequency of the third party media device 140 and the split-type host 120, respectively, are acquired. The first sampling frequency is a sampling frequency included in the first audio decoding parameter, and the second sampling frequency is a sampling frequency included in the second audio decoding parameter. When the first sampling frequency is greater than the second sampling frequency, the third party media device 140 is determined as the device with a superior converting capability. When the first sampling frequency is smaller than the second sampling frequency, the split-type host 120 is determined as the device with a superior converting capability.

It should be noted that the sampling frequency refers to a number of audio samples per second, which may be 32 KHz, 48 KHz, 96 KHz or the like. Embodiments of the present disclosure are not limited thereto.

The greater the sampling frequency of the device is, the better the audio playing quality of the audio information may become. Accordingly, the device having a greater sampling frequency may be determined as the device with a superior converting capability.

Similarly, when the first number equals to the second number, and when the first and second audio decoding parameters further include a number of audio channel, a first number of audio channel and a second number of audio channel of the third party media device 140 and the split-type host 120, respectively, are acquired. The first number of audio channel is a number of audio channel included in the first audio decoding parameter, and the second number of audio channel is a number of audio channel included in the second audio decoding parameter. When the first number of audio channel is greater than the second number of audio channel, the third party media device 140 is determined as the device with a superior converting capability. When the first number of audio channel is smaller than the second number of audio channel, the split-type host 120 is determined as the device with a superior converting capability.

It should be noted that the number of audio channels is a number of the audio channel(s) that may be supported by the device, which may be a single-channel, a 4-channel, a 5-channel, or the like. Embodiments of the present disclosure are not limited thereto.

In the case where the device has more audio channels, the device may have a greater signal-noise ratio, which may in turn generate less noise, thereby having a better audio playing quality when playing audio information. Accordingly, the device having more audio channels may be determined as the device with a superior converting capability.

Similarly, when the first number equals to the second number, and when the first and second audio decoding parameters further include the sampling frequency and the number of audio channel, the first sampling frequency and the second sampling frequency of the third party media device 140 and the split-type host 120, respectively, are acquired. When the first sampling frequency is greater than the second sampling frequency, the third party media device 140 is determined as the device with a superior converting capability. When the first sampling frequency is smaller than the second sampling frequency, the split-type host 120 is determined as the device with a superior converting capability.

When the first sampling frequency equals to the second sampling frequency, the first number of audio channel and the second number of audio channel of the third party media device 140 and the split-type host 120, respectively, are further acquired. When the first number of audio channel is greater than the second number of audio channel, the third party media device 140 is determined as the device with a superior converting capability. When the first number of audio channel is smaller than the second number of audio channel, the split-type host 120 is determined as the device with a superior converting capability.

Obviously, when the first and second audio decoding parameters further include the sampling frequency and the number of audio channel, it is possible to firstly acquire the first number of audio channels and the second number of audio channels. When the first number of audio channels is greater than the second number of audio channel, the third party media device 140 is determined as the device with a superior converting capability. When the first number of audio channels is smaller than the second number of audio channel, the split-type host 120 is determined as the device with a greater converting capability. When the first number of audio channels equals to the second number of audio channels, the first sampling frequency and the second sampling frequency of the third party media device 140 and the split-type host 120, respectively, are further acquired. When the first sampling frequency is greater than the second sampling frequency, the third party media device 140 is determined as the device with a superior converting capability. When the first sampling frequency is smaller than the second sampling frequency, the split-type host 120 is determined as the device with a superior converting capability. Embodiments of the present disclosure are not limited thereto.

Further, when the first number equals to the second number, and when the first audio decoding parameter and the second audio decoding parameter include only the scheme for audio decoding, the split-type host 120 may select the device with a greater converting capability according to a first decoding order. The first decoding order may be determined by sorting all the schemes for audio decoding that may be used to decode audio information, according to the decoding effect thereof.

In one embodiment, when the split-type host 120 acquires the first audio decoding parameter and the second audio decoding parameter, and when the first decoding order is pre-stored in the split-type host 120, the split-type host 120 may determine a sort position in the first decoding order of the scheme for audio decoding included in the first audio decoding parameter, and determine a sort position in the first decoding order of the scheme for audio decoding included in the second audio decoding parameter. When the first decoding order is sorted in an order from a better decoding effect to a poorer decoding effect, the device having the scheme for audio decoding with the headmost sort order closest to the better decoding effect may be determined as the device with a superior converting capability. When the first decoding order is sorted in an order from a poorer decoding effect to a better decoding effect, the device having the scheme for audio decoding with the last sort order closer to the better decoding effect may be determined as the device with a superior converting capability. However, if one or some scheme(s) for audio decoding is(are) included both in the first audio decoding parameter and the second audio decoding parameter, the split-type 120 host may acquire other schemes for audio decoding that are included either in the first audio decoding parameter or the second audio decoding parameter. When the first decoding order is sorted in an order from a better decoding effect to a poorer decoding effect, the device having the scheme for audio decoding with the headmost sort order among the different schemes for audio decoding may be determined as the device with a superior converting capability. When the first decoding order is sorted in an order from a poorer decoding effect to a better decoding effect, the device having the scheme for audio decoding with the last sort order among the different schemes for audio decoding may be determined as the device with a superior converting capability.

Further, when the first decoding order is pre-stored in the split-type host 120, the split-type host 120 may not only select the device with a greater converting capability based on the above method, but also may compare the schemes for audio decoding included in the first audio decoding parameter and the schemes for audio decoding included in the second decoding parameter one by one according to the first decoding order. As the first decoding order is determined by sorting all the schemes for audio decoding that may be used to decode audio information according to the decoding effect thereof, the device having the scheme for audio decoding with the best audio decoding effect may be determined as the device with a greater converting capability. Similarly, if one or some scheme(s) for audio decoding is(are) included both in the first audio decoding parameter and the second audio decoding parameter, the split-type host may acquire other schemes for audio decoding that are included either in the first audio decoding parameter or the second audio decoding parameter, and the device having the scheme for audio decoding with the best audio decoding effect may be determined as the device with a superior converting capability.

For example, the first decoding order may be sorted in an order from a better decoding effect to a poorer decoding effect and the first decoding order stored in the split-type host is DTS, AC3, PCM, and LPC. The schemes for audio decoding included in the first audio decoding parameter are PCM and AC3, and the schemes for audio decoding included in the second audio decoding parameter are PCM and LPC. As both the first audio decoding parameter and the second audio decoding parameter include the scheme for audio decoding of PCM, the split-type host may only compare the scheme for audio decoding of AC3 and the scheme for audio decoding of PCL according to the first decoding order. It may be determined that the AC3 may have a decoding effect better than that of the PCL, and thus the third party media device 140 may be determined as the device with a superior converting capability.

Optionally, the split-type host 120 may also sort the schemes for audio decoding included in the first audio decoding parameter and the schemes for audio decoding included in the second audio decoding parameter directly based on the decoding effect thereof, to obtain a second decoding order. Afterwards, the split-type host 120 may determine the device having the scheme for audio decoding with the best audio decoding effect as the device with a superior converting capability based on the second decoding order. Similarly, if one or some scheme(s) for audio decoding is(are) included both in the first audio decoding parameter and the second audio decoding parameter, the split-type host 120 may acquire other schemes for audio decoding that are included either in the first audio decoding parameter or the second audio decoding parameter, and may sort the different schemes for audio decoding based on the decoding effect thereof. Accordingly, the device having the scheme for audio decoding with the best audio decoding effect may be determined as the device with a superior converting capability.

It should be noted that the first decoding order may be pre-stored in the split-type host 120, which is not limited in the embodiments of the present disclosure.

Further, in the first decoding order, the schemes for audio decoding may be sorted in in an order from a better decoding effect to a poorer decoding effect, or may be sorted in an order from a poorer decoding effect to a better decoding effect, which is not limited in the embodiments of the present disclosure. Likewise, in the second decoding order, the schemes for audio decoding may be sorted in in an order from a better decoding effect to a poorer decoding effect, or may be sorted in an order from a poorer decoding effect to a better decoding effect, which is not limited in the embodiments of the present disclosure.

It should be noted that, the split-type host 120 may determine the quality of the decoding effect according to a required bandwidth of the scheme for audio decoding, thereby sorting the scheme for audio decoding according to the decoding effect thereof. However, the split-type host 120 may sort the scheme for audio decoding according to the quality of the decoding effect determined according to other ways, which is not limited in the embodiments of the present disclosure.

In addition, when the split-type host 120 and the third party media device 140 have the same converting capability, the split-type host 120 may select a device randomly from between the split-type host 120 and the third party media device 140, which is not limited in the embodiments of the present disclosure.

Further, before selecting the device with a greater converting capability from between the third party media device 140 and the split-type host 120 according to the first audio decoding parameter and a second audio decoding parameter, the split-type host 120 may further read the EDID of the split-type host 120 and acquire the second audio decoding parameter from the EDID of the split-type host 120.

In one embodiment, manners for the split-type host 120 to obtain the second audio decoding parameter from the EDID of the split-type host 120 may refer to the manners for the split-type host 120 to obtain the first audio decoding parameter, which will not be repeated herein.

In step 403, the audio may be played by the selected device.

In addition to being externally connected to the third party media device 140, the split-type host 120 may be further externally connected to a third party player source 110, and thus when the third party player source 110 externally connected to the split-type host 120 also has an audio playing function, the split-type host 120 may further acquire a third audio decoding parameter. The third audio decoding parameter is an audio decoding parameter of the third party player source 110. A device with a superior converting capability may be selected from the third party media device 140, the split-type host 120, and the third party player source 110, according to the first audio decoding parameter, the second audio decoding parameter and the third audio decoding parameter.

In one embodiment, operation for the split-type host 120 to acquire the third audio decoding parameter may refer to the operation for the split-type host 120 to acquire the first audio decoding parameter, which will not be repeated herein.

Further, the method for the split-type host 120 to select the device with a superior converting capability from the third party media device 140, the split-type host 120, and the third party player source 110, according to the first audio decoding parameter, the second audio decoding parameter and the third audio decoding parameter may refer to the above step 402, which will not be repeated herein.

It should be noted that the third party player source 110 may refer to a player source of the audio information, and the third party player source 110 may be a disc player, an audio player or the like, which is not limited in the embodiments of the present disclosure.

Further, the split-type host 120 may be further externally connected to a plurality of devices having an audio playing function, and the split-type host 120 may compare the split-type host 120 with the plurality of devices on by one and select the device with the superior converting capability to play the audio. That is, the split-type host 120 may select the device having the best playing effect to play the audio. Embodiments of the present disclosure are not limited thereto.

In the embodiments of the present disclosure, as both the split-type host 120 and the third party media device 140 may play audio and may have different playing effects, it is possible to compare the first audio decoding parameter with the second audio decoding parameter, so as to select a device with a superior converting capability as the device for playing audio, thereby improving an audio playing effect and an accuracy of device selection.

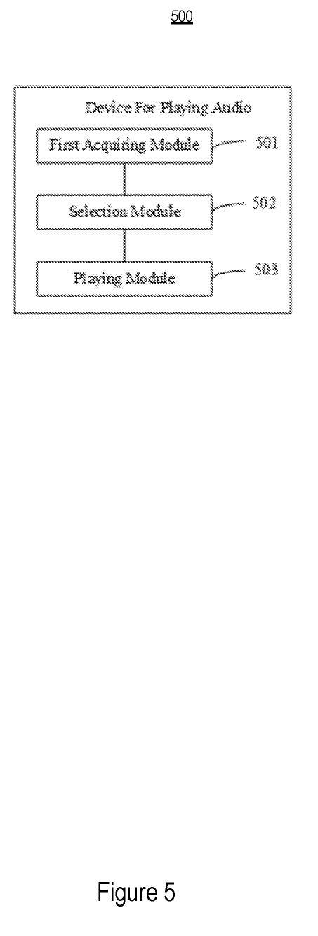

FIG. 5 is a block diagram illustrating a device 500 for playing audio according to an exemplary embodiment. Referring to FIG. 5, the device 500 may include a first acquiring module 501, a selection module 502 and a playing module 503.

The first acquiring module 501 is configured to acquire a first audio decoding parameter, wherein the first audio decoding parameter is an audio decoding parameter of, for example, the third party media device 140 externally connected to, for example, the split-type host 120, and the first audio decoding parameter is used for describing a converting capability for converting a digital audio signal into an analog audio signal.

The selection module 502 is configured to select a device with a superior converting capability from the third party media device 140 and the split-type host 120 according to the first audio decoding parameter and a second audio decoding parameter, wherein the second decoding parameter is an audio decoding parameter of the split-type host 120.

The playing module 503 is configured to play the audio using the selected device.

In one embodiment, both the first and second audio decoding parameters include at least a scheme for audio decoding.

In another embodiment of the present disclosure, the first and second audio decoding parameters further include at least one of a sampling frequency and a number of audio channel.

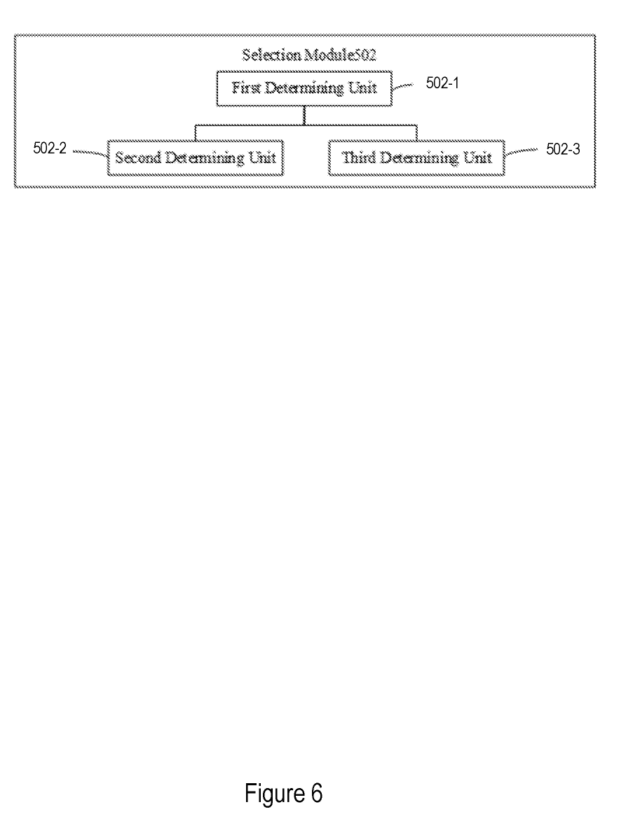

In another embodiment of the present disclosure, referring to FIG. 6, the selection module 502 from device 500 may include a first determining unit 502-1, a second determining unit 502-2 and a third determining unit 502-3.

The first determining unit 502-1 is configured to determine a first number and a second number, wherein the first number is a number of the scheme for audio decoding included in the first audio decoding parameter, and the second number is a number of the scheme for audio decoding included in the second audio decoding parameter.

The second determining unit 502-2 is configured to determine that the third party media device 140 is the device with a superior converting capability when the first number is greater than the second number.

The third determining unit 502-3 is configured to determine that the split-type host 120 is the device with a superior converting capability when the first number is smaller than the second number.

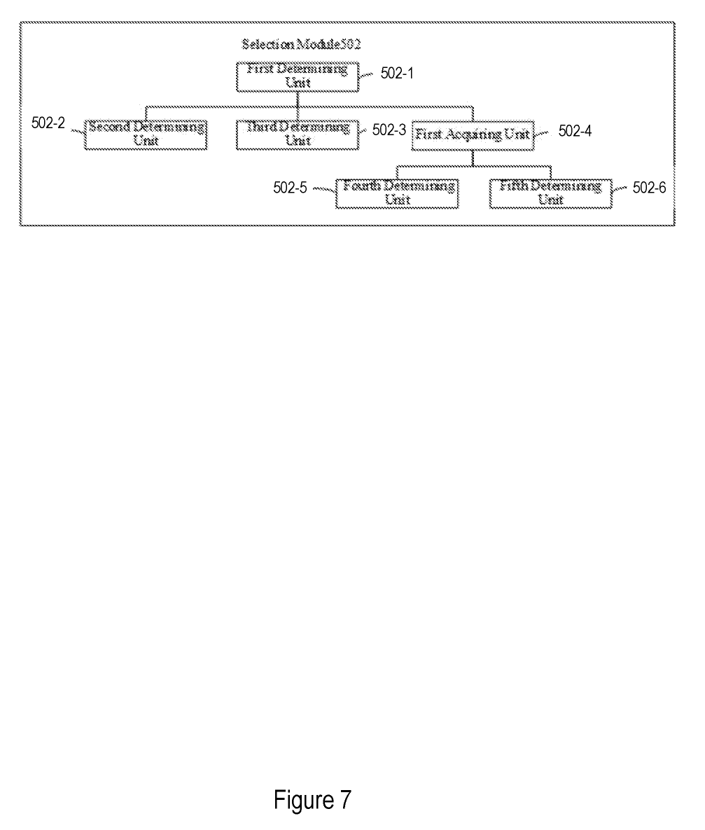

In another embodiment of the present disclosure, referring to FIG. 7, the selection module 502 may further include a first acquiring unit 502-4, a fourth determining unit 502-5 and a fifth determining unit 502-6.

The first acquiring unit 502-4 is configured to acquire a first sampling frequency and a second sampling frequency, wherein the first sampling frequency is a sampling frequency included in the first audio decoding parameter, and the second sampling frequency is a sampling frequency included in the second audio decoding parameter, when the first number equals to the second number and when the first and second audio decoding parameters further include a sampling frequency.

The fourth determining unit 502-5 is configured to determine that the third party media device 140 is the device with a superior converting capability when the first sampling frequency is greater than the second sampling frequency; and

The fifth determining unit 502-6 is configured to determine that the split-type host 120 is the device with a superior converting capability when the first sampling frequency is smaller than the second sampling frequency.

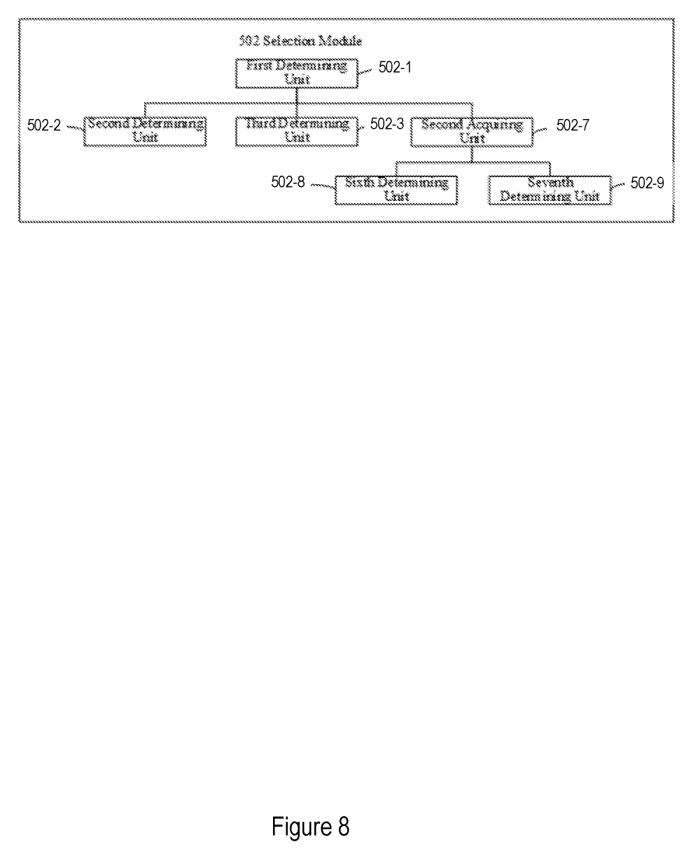

In another embodiment of the present disclosure, referring to FIG. 8, the selection module 502 may further include a second acquiring unit 502-7, a sixth determining unit 502-8 and a seventh determining unit 502-9.

The second acquiring unit 502-7 is configured to acquire a first number of audio channels and a second number of audio channels, wherein the first number of audio channels is a number of audio channels included in the first audio decoding parameter, and the second number of audio channels is a number of audio channels included in the second audio decoding parameter, when the first number equals to the second number and when the first and second audio decoding parameters further include a number of audio channel.

The sixth determining unit 502-8 is configured to determine that the third party media device 140 is the device with a superior converting capability when the first number of audio channel is greater than the second number of audio channel.

The seventh determining unit 502-9 is configured to determine that the split-type host 120 is the device with a superior converting capability when the first number of audio channel is smaller than the second number of audio channel.

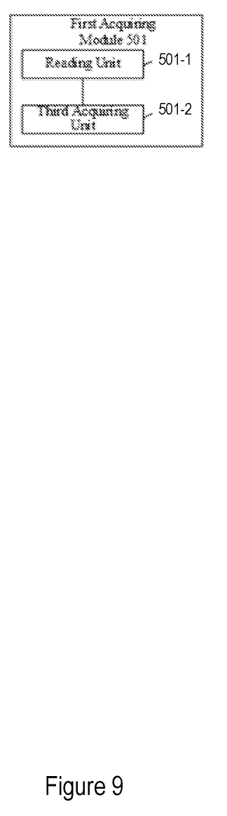

In another embodiment of the present disclosure, referring to FIG. 9, the first acquiring module 501 of the device 500 may include a reading unit 501-1 and a third acquiring unit 501-2.

The reading unit 501-1 is configured to read an extended display identification data (EDID) of the third party media device 140 through a designated interface.

The third acquiring unit 501-2 is configured to acquire the first audio decoding parameter from the EDID of the third party media device 140.

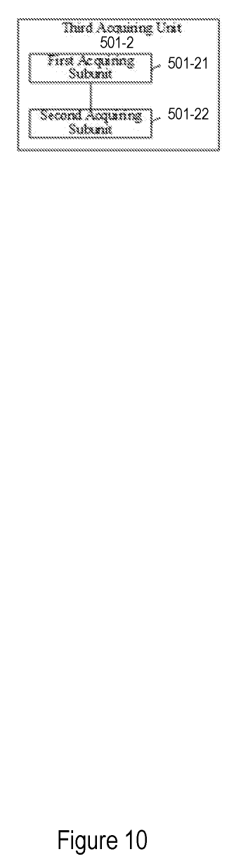

In another embodiment of the present disclosure, referring to FIG. 10, the third acquiring unit 501-2 may include a first acquiring subunit 501-21 and a second acquiring subunit 501-22.

The first acquiring subunit 501-21 is configured to acquire a data document from the EDID of the third party media device 140 according to a designated path.

The second acquiring subunit 501-22 is configured to acquire the first audio decoding parameter from the data document.

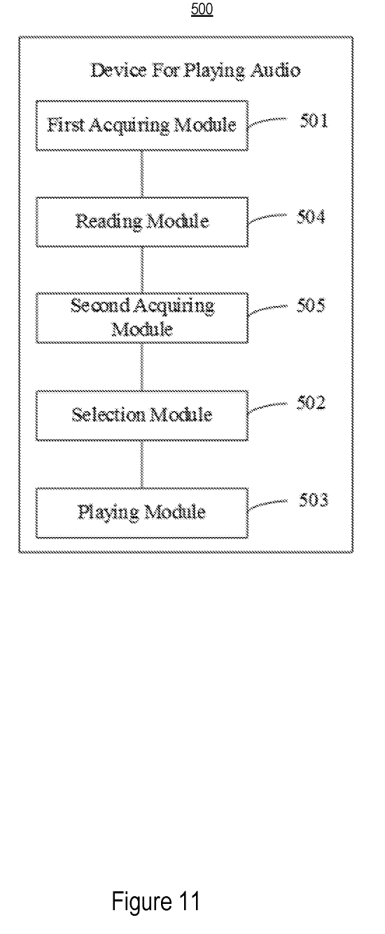

According to another embodiment of the present disclosure, referring to FIG. 11, the device 500 may further include a reading module 504 and a second acquiring module 505.

The reading module 504 is configured to read an EDID of the split-type host 120.

The second acquiring module 505 is configured to acquire the second audio decoding parameter from the EDID of the split-type host 120.

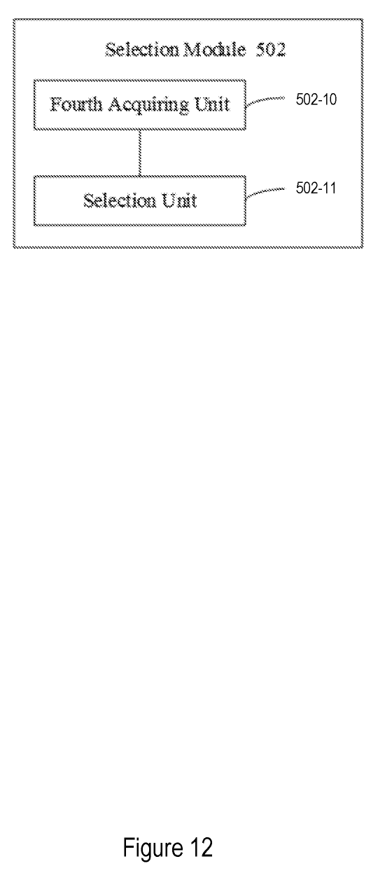

According to another embodiment of the present disclosure, referring to FIG. 12, the selection module 502 of device 500 may include a fourth acquiring unit 502-10 and a selection unit 502-11.

The fourth acquiring unit 502-10 is configured to acquire a third audio decoding parameter when the split-type host 120 is further externally connected to a third party player source 110 having an audio playing function, wherein the third audio decoding parameter is an audio decoding parameter of the third party player source 110.

The selection unit 502-11 is configured to select a device with a greater converting capability from the third party media device 140, the split-type host 120, and the third party player source 110, according to the first audio decoding parameter, the second audio decoding parameter and the third audio decoding parameter.

In the embodiments of the present disclosure, as both the split-type host 120 and the third party media device 140 may play audio and may have different playing effects, it is possible to compare the first audio decoding parameter with the second audio decoding parameter, so as to select a device with a superior converting capability as the device for playing audio, thereby improving an audio playing effect and an accuracy of device selection.

With respect to the devices in the above embodiments, the specific manners for performing operations for individual modules therein have been described in detail in the embodiments regarding the methods, which will not be elaborated herein. Each module, submodule, or unit discussed herein, may take the form of a packaged functional hardware unit designed for use with other components, a portion of a program code (e.g., software or firmware) executable by a processor, a processing component, or a processing circuitry that usually performs a particular function of related functions, or a self-contained hardware or software component that interfaces with a larger system, for example.

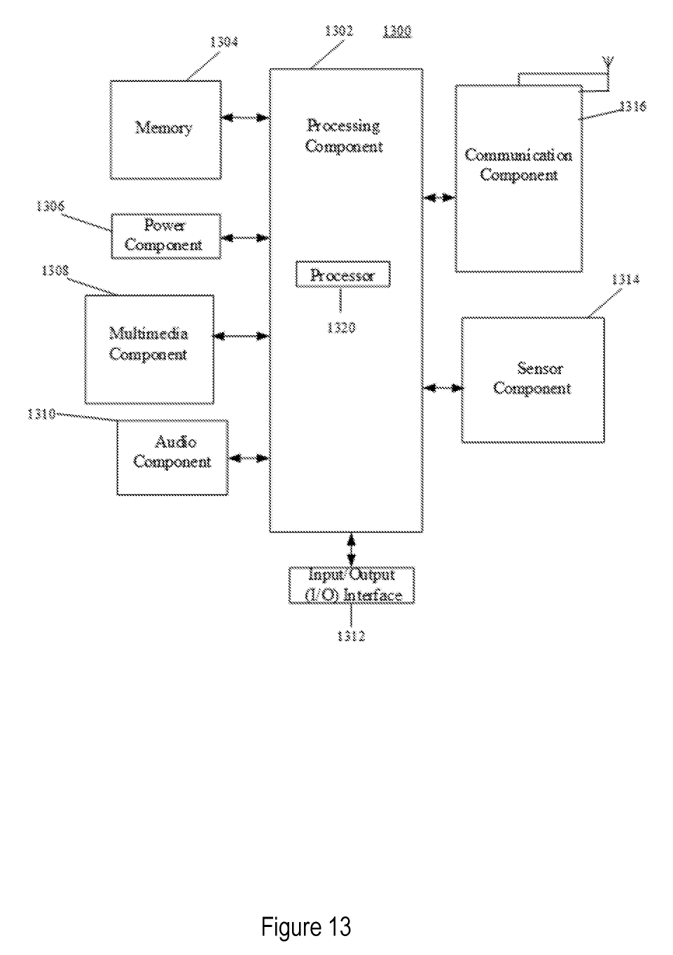

FIG. 13 is a block diagram of a device 1300 for playing audio, according to an exemplary embodiment. For example, the device 1300 may be a mobile phone, a computer, a digital broadcast terminal, a messaging device, a gaming console, a tablet, a medical device, exercise equipment, a personal digital assistant, and the like. The device 1300 may be representative of the third party player source 110, split-type host 120, standalone screen 130, or third party media device 140.

Referring to FIG. 13, the device 1300 may include one or more of the following components: a processing component 1302, a memory 1304, a power component 1306, a multimedia component 1308, an audio component 1310, an input/output (I/O) interface 1312, a sensor component 1314, and a communication component 1316.

The processing component 1302 typically controls overall operations of the device 1300, such as the operations associated with display, telephone calls, data communications, camera operations, and recording operations. The processing component 1302 may include one or more processors 1320 to execute instructions to perform all or part of the steps in the above described methods. Moreover, the processing component 1302 may include one or more modules which facilitate the interaction between the processing component 1302 and other components. For instance, the processing component 1302 may include a multimedia module to facilitate the interaction between the multimedia component 1308 and the processing component 1302.

The memory 1304 is configured to store various types of data to support the operation of the device 1300. Examples of such data include instructions for any applications or methods operated on the device 1300, contact data, phonebook data, messages, pictures, video, etc. The memory 1304 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 1306 provides power to various components of the device 1300. The power component 1306 may include a power management system, one or more power sources, and any other components associated with the generation, management, and distribution of power in the device 1300.

The multimedia component 1308 includes a screen providing an output interface between the device 1300 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 1308 includes a front camera and/or a rear camera. The front camera and the rear camera may receive an external multimedia datum while the device 1300 is in an operation mode, such as a photographing mode or a video mode. Each of the front camera and the rear camera may be a fixed optical lens system or have focus and optical zoom capability.

The audio component 1310 is configured to output and/or input audio signals. For example, the audio component 1310 includes a microphone (“MIC”) configured to receive an external audio signal when the device 1300 is in an operation mode, such as a call mode, a recording mode, and a voice recognition mode. The received audio signal may be further stored in the memory 1304 or transmitted via the communication component 1316. In some embodiments, the audio component 1310 further includes a speaker to output audio signals.

The I/O interface 1312 provides an interface between the processing component 1302 and peripheral interface modules, such as a keyboard, a click wheel, buttons, and the like. The buttons may include, but are not limited to, a home button, a volume button, a starting button, and a locking button.

The sensor component 1314 includes one or more sensors to provide status assessments of various aspects of the device 1300. For instance, the sensor component 1314 may detect an open/closed status of the device 1300, relative positioning of components, e.g., the display and the keypad, of the device 1300, a change in position of the device 1300 or a component of the device 1300, a presence or absence of user contact with the device 1300, an orientation or an acceleration/deceleration of the device 1300, and a change in temperature of the device 1300. The sensor component 1314 may include a proximity sensor configured to detect the presence of nearby objects without any physical contact. The sensor component 1314 may also include a light sensor, such as a CMOS or CCD image sensor, for use in imaging applications. In some embodiments, the sensor component 1314 may also include an accelerometer sensor, a gyroscope sensor, a magnetic sensor, a pressure sensor, or a temperature sensor.

The communication component 1316 is configured to facilitate communication, wired or wirelessly, between the device 1300 and other devices. The device 1300 can access a wireless network based on a communication standard, such as WiFi, 2G; or 3G or a combination thereof. In one exemplary embodiment, the communication component 1316 receives a broadcast signal or broadcast associated information from an external broadcast management system via a broadcast channel. In one exemplary embodiment, the communication component 1316 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the device 1300 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer-readable storage medium including instructions, such as included in the memory 1304, executable by the processor 1320 in the device 1300, for performing the above-described methods. For example, the non-transitory computer-readable storage medium may be a ROM, a RAM, a CD-ROM, a magnetic tape, a floppy disc, an optical data storage device, and the like.

A non-transitory computer-readable storage medium storing instructions, when being executed by a processor in a smart device, causes the smart device to perform a method for playing audio. The method may include the steps as follows.

A first audio decoding parameter is acquired. The first audio decoding parameter is an audio decoding parameter of a third party media device externally connected to a split-type host, and the first audio decoding parameter is used for describing a converting capability for converting a digital audio signal into an analog audio signal.

A device with a greater converting capability is selected from between the third party media device and the split-type host according to the first audio decoding parameter and a second audio decoding parameter. The second decoding parameter is an audio decoding parameter of the split-type host.

The audio is played using the selected device.

In the present embodiment, both the first and second audio decoding parameters include at least a scheme for audio decoding.

In another embodiment of the present disclosure, the first and second audio decoding parameters may further include at least one of a sampling frequency and a number of audio channels.

In another embodiment of the present disclosure, the step of selecting a device with a superior converting capability from the third party media device and the split-type host according to the first audio decoding parameter and a second audio decoding parameter includes the steps as follows.

A first number and a second number are determined. The first number is a number of the scheme for audio decoding included in the first audio decoding parameter, and the second number is a number of the scheme for audio decoding included in the second audio decoding parameter.

When the first number is greater than the second number, it is determined that the third party media device is the device with a superior converting capability.

When the first number is smaller than the second number, it is determined that the split-type host is the device with a superior converting capability.

In another embodiment of the present disclosure, after the step of determining the first number and the second number, the method may further include the steps as follows.

When the first number equals to the second number and when the first and second audio decoding parameters further include a sampling frequency, a first sampling frequency and a second sampling frequency are acquired. The first sampling frequency is a sampling frequency included in the first audio decoding parameter, and the second sampling frequency is a sampling frequency included in the second audio decoding parameter.

When the first sampling frequency is greater than the second sampling frequency, it is determined that the third party media device is the device with a superior converting capability.

When the first sampling frequency is smaller than the second sampling frequency, it is determined that the split-type host is the device with a superior converting capability.

In another embodiment of the present disclosure, after the step of determining the first number and the second number, the method may further include the steps as follows.

When the first number equals to the second number and when the first and second audio decoding parameters further include a number of audio channel, a first number of audio channel and a second number of audio channel are acquired. The first number of audio channel is a number of audio channel included in the first audio decoding parameter, and the second number of audio channel is a number of audio channel included in the second audio decoding parameter.

When the first number of audio channel is greater than the second number of audio channel, it is determined that the third party media device is the device with a superior converting capability.

When the first number of audio channel is smaller than the second number of audio channel, it is determined that the split-type host is the device with a superior converting capability.

According to another embodiment of the present disclosure, the step of acquiring a first audio decoding parameter includes the steps as follows.

An extended display identification data (EDID) of the third party media device is read through a designated interface.

The first audio decoding parameter is acquired from the EDID of the third party media device.

According to another embodiment of the present disclosure, the step of acquiring the first audio decoding parameter from the EDID of the third party media device includes the steps as follows.

A data document is acquired from the EDID of the third party media device according to a designated path.

The first audio decoding parameter is acquired from the data document.

According to another embodiment of the present disclosure, before the step of selecting a device with a greater converting capability from between the third party media device and the split-type host according to the first audio decoding parameter and a second audio decoding parameter, the method includes the step as follows.

An EDID of the split-type host is read.

The second audio decoding parameter is acquired from the EDID of the split-type host.

According to another embodiment of the present disclosure, the step of selecting a device with a superior converting capability from the third party media device and the split-type host according to the first audio decoding parameter and a second audio decoding parameter includes the steps as follows.

When the split-type host is further externally connected to a third party player source having an audio playing function, a third audio decoding parameter is acquired. The third audio decoding parameter is an audio decoding parameter of the third party player source.

A device with a superior converting capability is selected from between the third party media device, the split-type host, and the third party player source, according to the first audio decoding parameter, the second audio decoding parameter and the third audio decoding parameter.

In the embodiments of the present disclosure, as both the split-type host and the third party media device may play audio and may have different playing qualities, it is possible to compare the first audio decoding parameter with the second audio decoding parameter, so as to select a device with a superior converting capability as the device for playing audio, thereby improving an audio playing effect and an accuracy of device selection.

Other embodiments of the disclosure will be apparent to those skilled in the art from consideration of the specification and practice of the disclosure disclosed herein. This application is intended to cover any variations, uses, or adaptations of the disclosure following the general principles thereof and including such departures from the present disclosure as come within known or customary practice in the art. It is intended that the specification and examples be considered as exemplary only, with a true scope and spirit of the disclosure being indicated by the following claims.

It will be appreciated that the present disclosure is not limited to the exact construction that has been described above and illustrated in the accompanying drawings, and that various modifications and changes can be made without departing from the scope thereof. It is intended that the scope of the disclosure only be limited by the appended claims.

What is claimed is:

1. A method for a split-type device to select a media device for playing audio, the method comprising:
acquiring, through a first designated interface, a first audio decoding parameter of a third party media device externally connected to the split-type device, the first audio decoding parameter describing a converting capability of the third party media device for converting a digital audio signal into an analog audio signal;
acquiring, through a second designated interface, a second audio decoding parameter of the split-type device, the second audio decoding parameter describing a converting capability of the split-type device for converting the digital audio signal into the analog audio signal;
comparing the first audio decoding parameter and the second audio decoding parameter;
selecting as a selected device one of the third party media device or the split-type device having a superior converting capability based on the comparison; and
controlling the selected device to play the audio, wherein both the first audio decoding parameter and the second audio decoding parameter describe a respective scheme for audio decoding.

2. The method of claim 1, wherein the first audio decoding parameter and the second audio decoding parameter further comprise at least one of a respective sampling frequency or a respective number of audio channels.

3. The method of claim 1, wherein selecting the selected device having the superior converting capability comprises:
determining a first number and a second number of the third party media device and the split-type device, respectively, the first number being a number of the scheme for audio decoding included in the first audio decoding parameter, and the second number being a number of the scheme for audio decoding included in the second audio decoding parameter;
determining that the third party media device is the selected device having the superior converting capability when the first number is greater than the second number; and
determining that the split-type device is the selected device having the superior converting capability when the first number is less than the second number.

4. The method of claim 3, further comprising:
when the first number equals the second number and when the first audio decoding parameter and the second audio decoding parameter further comprise a respective sampling frequency for the third party media device and the split-type device, acquiring a first sampling frequency included in the first audio decoding parameter for the third party media device and acquiring a second sampling frequency included in the second audio decoding parameter for the split-type device;
determining that the third party media device is the selected device having the superior converting capability when the first sampling frequency is greater than the second sampling frequency; and
determining that the split-type host is the selected device having the superior converting capability when the first sampling frequency is less than the second sampling frequency.

5. The method of claim 3, further comprising:
when the first number equals the second number and when the first audio decoding parameter and the second audio decoding parameter further comprise a respective number of audio channels, acquiring a first number of audio channels included in the first audio decoding parameter for the third party media device and acquiring a second number of audio channels included in the second audio decoding parameter for the split-type device;
determining that the third party terminal is the selected device having the superior converting capability when the first number of audio channels is greater than the second number of audio channels; and
determining that the split-type device is the selected device having the superior converting capability when the first number of audio channels is less than the second number of audio channels.

6. The method of claim 1, wherein acquiring the first audio decoding parameter comprises:
reading an extended display identification data (EDID) of the third party media device through the designated interface; and
acquiring the first audio decoding parameter from the EDID of the third party media device.

7. The method of claim 6, wherein acquiring the first audio decoding parameter from the EDID of the third party media device comprises:
acquiring a data document from the EDID of the third party media device according to a designated path; and
acquiring the first audio decoding parameter from the data document.

8. The method of claim 1, further comprising: reading an extended display identification data (EDID) of the split-type device; and
acquiring the second audio decoding parameter from the EDID of the split-type device.

9. The method of claim 1, wherein selecting the selected device having the superior converting capability comprises:
acquiring a third audio decoding parameter when the split-type device is further connected to a third party player device having an audio playing function, the third audio decoding parameter being an audio decoding parameter of the third party player device; and
selecting the selected device having the superior converting capability from the third party media device, the split-type device, and the third party player device, according to the first audio decoding parameter, the second audio decoding parameter and the third audio decoding parameter.

10. A device for playing audio, comprising:
a processor; and
a memory for storing instructions executable by the processor,
wherein the processor is configured to execute the instructions to:
acquire, through a first designated interface, a first audio decoding parameter of a third party media device externally connected to a split-type device, the first audio decoding parameter describing a converting capability of the third party media device for converting a digital audio signal into an analog audio signal;
acquire, through a second designated interface, a second audio decoding parameter of the split-type device, the second audio decoding parameter describing a converting capability of the split-type device for converting the digital audio signal into the analog audio signal;
compare the first audio decoding parameter and the second audio decoding parameter;
select as a selected device one of the third party media device or the split-type device having a superior converting capability based on the comparison; and
control the selected device to play the audio, wherein both the first audio decoding parameter and the second audio decoding parameter describe a respective scheme for audio decoding.

11. The device of claim 10, wherein the first audio decoding parameter and the second audio decoding parameter further comprise at least one of a respective sampling frequency or a respective number of audio channels.

12. The device of claim 10, wherein the processor, to select the selected device having the superior converting capability, is configured to:
determine a first number and a second number of the third party media device and the split-type device, respectively, the first number being a number of the scheme for audio decoding included in the first audio decoding parameter, and the second number being a number of the scheme for audio decoding included in the second audio decoding parameter;
determine that the third party media device is the selected device having the superior converting capability when the first number is greater than the second number; and
determine that the split-type device is the selected device having the superior converting capability when the first number is less than the second number.

13. The device of claim 12, wherein the processor is further configured to execute the instructions to:
when the first number equals the second number and when the first audio decoding parameter and the second audio decoding parameter further comprise a respective sampling frequency for the third party media device and the split-type device, acquire a first sampling frequency included in the first audio decoding parameter for the third party media device and acquiring a second sampling frequency included in the second audio decoding parameter for the split-type device;
determine that the third party media device is the selected device having the superior converting capability when the first sampling frequency is greater than the second sampling frequency; and
determine that the split-type host is the selected device having the superior converting capability when the first sampling frequency is less than the second sampling frequency.

14. The device of claim 12, wherein the processor is configured to:
when the first number equals the second number and when the first audio decoding parameter and the second audio decoding parameter further comprise a respective number of audio channels, acquire a first number of audio channels included in the first audio decoding parameter for the third party media device and acquiring a second number of audio channels included in the second audio decoding parameter for the split-type device;
determine that the third party terminal is the selected device having the superior converting capability when the first number of audio channels is greater than the second number of audio channels; and
determine that the split-type device is the selected device having the superior converting capability when the first number of audio channels is less than the second number of audio channels.

15. The device of claim 10, wherein the processor, to acquire the first audio decoding parameter , is configured to:
read an extended display identification data (EDID) of the third party media device through a designated interface; and
acquire the first audio decoding parameter from the EDID of the third party media device.

16. The device of claim 15, wherein the processor, to acquire the first audio decoding parameter from the EDID of the third party media device, is configured to:
acquire a data document from the EDID of the third party media device according to a designated path; and
acquire the first audio decoding parameter from the data document.

17. The device of claim 10, wherein the processor is further configured to:
read an extended display identification data (EDID) of the split-type device; and
acquire the second audio decoding parameter from the EDID of the split-type device.

18. The device of claim 10, wherein the processor is configured to select the selected device having the greater converting capability to:
acquire a third audio decoding parameter when the split-type device is further connected to a third party player device having an audio playing function, the third audio decoding parameter being an audio decoding parameter of the third party player device; and
select the selected device having the superior converting capability from the third party media device, the split-type device, and the third party player device, according to the first audio decoding parameter, the second audio decoding parameter and the third audio decoding parameter.

19. A non-transitory computer-readable storage medium having stored therein instructions to cause a processor of a device to perform a method for playing audio, the instructions comprising instructions to:
acquire, through a first designated interface, a first audio decoding parameter of a third party media device externally connected to a split-type device, the first audio decoding parameter describing a converting capability of the third party media device for converting a digital audio signal into an analog audio signal;
acquire, through a second designated interface, a second audio decoding parameter of the split-type device, the second audio decoding parameter describing a converting capability of the split-type device for converting the digital audio signal into the analog audio signal;
compare the first audio decoding parameter and the second audio decoding parameter;
select a selected device having a superior converting capability between the third party media device and the split-type device based on the comparison; and
control the selected device to play the audio, wherein both the first audio decoding parameter and the second audio decoding parameter describe a respective scheme for audio decoding.
